(19) United States
(12) Patent Application Publication
(10) Pub. No.: US 2013/0208357 A1
(43) Pub. Date: Aug. 15, 2013

(54) AUTOSTEREOSCOPIC DISPLAY APPARATUS

(71) Applicant: JVC KENWOOD CORPORATION, (US)

(72) Inventor: Atsushi SAITO, Yokohama-shi, Kanagawa (JP)

(73) Assignee: JVC KENWOOD CORPORATION, Yokohama-shi (JP)

(21) Appl. No.: 13/838,321

(22) Filed: Mar. 15, 2013

Related U.S. Application Data
(63) Continuation of application No. PCT/JP2011/072605, filed on Sep. 30, 2011.

(30) Foreign Application Priority Data
Oct. 5, 2010 (JP) 2010-225678

(51) Int. Cl. G02B 27/22

(52) U.S. Cl. CPC G02B 27/2214
USPC 359/463

(57) ABSTRACT

An autostereoscopic display apparatus includes a two-dimensional display including color subpixels that are arranged in a horizontal direction and in a vertical direction, and a plurality of cylindrical lenses through which the color subpixels are observed. px is a horizontal pixel pitch of the color subpixels, py is a vertical pixel pitch of the color subpixels, Lx is a horizontal lens pitch of the cylindrical lenses, and θ is an inclined angle of boundaries to the vertical direction. Ax and Ay are relatively prime natural numbers, Ax is equal to or larger than two, and Bx is a minimum natural number by which a value GF indicated in the formula (2) represents an integer value. Px, py, Lx and θ satisfy the relational expressions represented by the formula (1) to the formula (3).

θ=arctan {(Ax·px)/(Ay·py)) } (1)

GF=Bx·Lx/px (2)

Ay≧Bx≧2 and Ax≧2 (3)

### CROSS REFERENCE TO RELATED APPLICATION

This application is a Continuation of PCT Application No. PCT/JP2011/072605, filed on Sep. 30, 2011, and claims the priority of Japanese Patent Application No. 2010-225678, filed on Oct. 5, 2010, the contents of both of which are incorporated herein by reference.

### BACKGROUND

The present invention relates to an autostereoscopic display apparatus by use of a parallax in a one-dimensional direction.

There are conventionally-known methods for displaying different images depending on viewing positions by segmenting an image in a display apparatus such as a printing surface and a liquid crystal panel in multiple viewing directions by use of particular optical members, for example, lenticular lenses, slit-type barriers and lens arrays. In particular, different display images (parallax images) having a particular parallax with respect to an identical object are configured to be input to the respective right and left eyes. Accordingly, a stereoscopic image display apparatus capable of stereoscopic viewing without eyeglasses (hereinafter, referred to as “an autostereoscopic display apparatus”) is realized. Note that, in the present application, a direction to segment an image in a display apparatus into parallax images is principally one dimension in a horizontal direction.

In the case of carrying out stereoscopic viewing by use of an autostereoscopic display apparatus, an image in the display apparatus is required to be segmented into parallax images in many directions as much as possible to increase viewpoints, so as to extend a viewing range capable of stereoscopic viewing, and so as to achieve a natural stereoscopic effect and smooth motion parallax for allowing for long hours of viewing.

In recent years, applications of stereoscopic viewing by use of parallax images to digital signage, car navigation systems and the like are being considered for eye catching and visual recognition improvement. In order to achieve such applications, even when a low-resolution display apparatus is used, an image in the display apparatus is required to be segmented into parallax images as finely as possible to carry out natural stereoscopic viewing.

As a measure of such a requirement, segmenting a viewpoint as finely as possible is an effective way so that a viewer can view any of the segmented viewpoints (a multi-view system), rather than segmenting the viewpoint while assuming a location of the eyes of the viewer in space. In order to increase the segmentation number of the parallax images, increasing a lens pitch with respect to a pixel pitch of the display apparatus is effective. However, in this case, resolution of the parallax images in a lens pitch direction is significantly reduced since color subpixels are magnified due to a magnification effect of lenses in proportion to the increase of the lens pitch. As a result, a problem of a difference in resolution between a horizontal direction and a vertical direction is caused.

In Patent Document 1 (Japanese Patent Unexamined Publication No. 09-236777), lenticular lenses are inclined with respect to a pixel array so as to compose one three-dimensional pixel by use of subpixels in a vertical direction in addition to subpixels in a horizontal direction. Patent Document 1 has reported that a reduction in resolution of a three-dimensional view is thus prevented, and the balance of the resolutions in the horizontal direction and in the vertical direction can be improved.

In view of coexistence with a two-dimensional view and a matter of cost, an autostereoscopic display apparatus is being required, which uses a widely prevalent display apparatus including color subpixels of R (red), G (green) and B (blue) in which the color subpixels of each color are orderly arranged in a vertical direction.

Patent Documents 2 (Japanese Patent Unexamined Publication No. 2005-309374) and 3 (Japanese Patent Unexamined Publication No. 2006-048659) teach an equal arrangement of color subpixels of each of three colors in each line in a horizontal direction while focusing on an inclined angle of lenticular lenses with respect to a display apparatus. It has been reported that unevenness of color and luminance can be decreased due to such a constitution even when using a display apparatus in which color subpixels of different colors, for example, color subpixels of respective R (red), G (green) and B (blue) different in a horizontal direction are arranged in a vertical direction in a stripe state. In addition, FIG. 1 of Patent Document 2 shows a constitution in which a lens pitch of the lenticular lenses is 7/2 of a pixel pitch so that seven segmented parallax images are arranged across two lenses in the horizontal direction. Therefore, when the lens pitch is deviated from the integral multiple of the pixel pitch, a fine segmentation of the parallax images in multiple directions can be achieved even if the lens pitch is small. Accordingly, it is possible to deal with the problem and requirement described above.

### SUMMARY

However, there has been a problem of generation of oblique line noise parallel to lens boundaries as described below since the segmented parallax images are arranged across the several lenses when the lens pitch in the horizontal direction is deviated from the integral multiple of the pixel pitch.

FIG. 17(a) shows a relative positional relationship between an arrangement pattern (rectangle) of color subpixels 53 and lenticular lenses 52a and 52b provided in a display apparatus, in which the diagonal lines represent boundaries bl1 to bl3 of the lenticular lenses 52a and 52b adjacent to each other. The numbers indicated in each subpixel 53 (1 to 7) represent the numbers of parallax images, which correspond to the display directions of the parallax images segmented in a horizontal direction. FIG. 17(b) shows an autostereoscopic display apparatus 50, the directions of parallax images SP1 to SP7, and the corresponding lenticular lenses 52a and 52b.

A horizontal lens pitch is 7/2 of a horizontal pixel pitch. The lenticular lens 52a corresponds to the parallax images SP2, SP4 and SP6, and the lenticular lens 52b corresponds to the parallax images SP1, SP3, SP5 and SP7. Namely, the segmented parallax images SP1 to SP7 are arranged across the two lenticular lenses 52a and 52b. As viewed through the lenticular lenses 52a and 52b, the color subpixels 53 corresponding to the respective parallax images are visually enlarged and maximized in the lens pitch in the lens pitch direction. Therefore, when observing the parallax image SP1, as shown in FIG. 17(c), the color subpixel 53 corresponding to the parallax image SP1 is not shown in the lenticular lens 52a, but shown in the lenticular lens 52b. Thus, although the parallax image SP1 can be viewed through the lenticular lens 52b, the parallax image SP1 cannot be viewed through the lenticular lens 52a.

As a result, oblique line noise parallel to the boundaries bl1 to bl3 of the lenticular lenses 52a and 52b is caused in the entire parallax view. In practice, an intermediate image of the parallax image SP7 and the parallax image SP2 is slightly viewed through the lenticular lens 52a. However, if the parallax image SP1, the parallax image SP2 and the parallax image SP7 have different corresponding color subpixels, oblique line noise is caused. Further, when the segmented parallax images are arranged across multiple lenticular lenses, the lenticular lenses in which there is no corresponding color subpixel and through which the parallax images are not viewed are increased. As a result, oblique line noise is caused more significantly.

FIG. 18 shows a simulation image when observing parallax images from one particular point. Here, an inclined angle of lenticular lenses with respect to a pixel pitch direction is set to 9.46° (≈arctan(1/6)), and a lens pitch in a horizontal direction is set to 61/8 of a pixel pitch; that is, 7.625 times. In addition, 61 segmented parallax images are arranged across eight lenses. A vertical pixel pitch in the display apparatus is three times as high as the horizontal pixel pitch. As is apparent from the figure, oblique line noise is caused along the boundaries of the lenticular lenses in the switched portions of the parallax images.

The present invention has been made in view of the above-described problems. It is an aspect of the present invention to provide an autostereoscopic display apparatus, including: a two-dimensional display including color subpixels that are arranged in a horizontal direction and in a vertical direction, respectively; and a plurality of cylindrical lenses provided on the two-dimensional display to observe the color subpixels therethrough, and arranged parallel to each other, wherein when a pixel pitch of the color subpixels in the horizontal direction is defined as px, a pixel pitch of the color subpixels in the vertical direction is defined as py, a lens pitch of the cylindrical lenses in the horizontal direction is defined as Lx, an inclined angle of boundaries of the cylindrical lenses to the vertical direction is defined as θ, Ax and Ay are relatively prime natural numbers, Ax is equal to or larger than two, and Bx is a minimum natural number by which a value GF indicated in the formula (2) represents an integer value, px, py, Lx and θ satisfy relational expressions represented by the formula (1) to the formula (3).

θ=arctan {(Ax·px)/(Ay·py)} (1)

GF=Bx·Lx/px (2)

Ay≧Bx≧2 and Ax≧2 (3)

It is another aspect of the present invention to provide an autostereoscopic display apparatus, including: a two-dimensional display that displays an image using a plurality of color subpixels; and a plurality of cylindrical lenses that segment the image displayed on the two-dimensional display into a plurality of parallax images, wherein an inclined angle of the cylindrical lenses with respect to the two-dimensional display is set in such a manner that the segmented parallax images are arranged across the cylindrical lenses, and all of the color subpixels composing the parallax images are displayed through each cylindrical lens.

### BRIEF DESCRIPTION OF THE DRAWINGS

FIG. 1(a) is a perspective view of an entire constitution of an autostereoscopic display apparatus according to a first embodiment of the present invention, and FIG. 1(b) is an enlarged plan view of a region M in FIG. 1(a).

FIG. 2 is a plan view showing a first comparative example in which an inclined angle θ of cylindrical lenses is set to θ=arctan(px/(2·py))=9.46°, and a lens pitch Lx in a horizontal direction is set to Lx=7·px.

FIG. 3 is a plan view showing a second comparative example in which θ is set to θ=9.46°, and a lens pitch Lx=L/cos θ in a horizontal direction is set to 13·px/4=3.25·px.

FIG. 4 is a plan view showing the first embodiment in which θ=10.23°, and Lx=3.25·px.

FIG. 5 is a schematic view explaining conditions that each parameter should fulfill in order to prevent unevenness of color.

FIG. 6 is a plan view showing a constitution of an autostereoscopic display apparatus according to Example 1.

FIG. 7 is a table showing preconditions of each parameter of the autostereoscopic display apparatus of FIG. 6.

FIG. 8 shows simulation images when observing 61 segmented parallax images from a particular point through cylindrical lenses in a similar manner to FIG. 18. FIG. 8(a) shows parallax images in which a designed lens pitch is maintained (a lens pitch is not broadened), and FIG. 8(b) shows parallax images reconstructed in accordance with the lenses of which a lens pitch is broadened.

FIG. 9 is a cross-sectional view showing a constitution of an autostereoscopic display apparatus according to a third embodiment of the present invention.

FIG. 10 is a plan view showing a positional relationship between color subpixels and a boundary BL1 of a cylindrical lens 12 in the case of Ny=2.

FIG. 11 is a plan view showing an arrangement of color subpixels in the case of Ny=1, Nx=2 and M=7 in a similar manner to FIG. 10.

FIG. 12 is a plan view showing an arrangement of color subpixels in the case of Ny=2, Nx=4 and M=15.

FIG. 13 is a schematic view explaining a function according to the third embodiment.

FIG. 14(a) is a plan view showing a state in which each set of color subpixels approximately composed of R, G and B corresponding to the same parallax image number is arranged along boundaries BL1 to BL3, and FIG. 14(b) is a plan view showing a state in which color subpixels of two of R, G and B are diagonally arranged as one set.

FIG. 15(a) is a table showing preconditions of each parameter of an autostereoscopic display apparatus according to Example 2, and FIG. 15(b) is a plan view showing a part of the autostereoscopic display apparatus according to Example 2 configured based on each parameter of FIG. 15(a).

FIG. 16(a) is a table showing preconditions of each parameter of an autostereoscopic display apparatus according to Example 3, and FIG. 16(b) is a plan view showing a part of the autostereoscopic display apparatus according to Example 3 configured based on each parameter of FIG. 16(a).

FIG. 17(a) to FIG. 17(c) are views explaining a cause of oblique line noise parallel to boundaries bl1 to bl3 of lenticular lenses 52a and 52b.

FIG. 18 is an image showing an example of oblique line noise generated in parallel with boundaries of lenticular lenses.

### DETAILED DESCRIPTION

Hereinafter, embodiments according to the present invention will be explained with reference to the drawings. Note that the same elements in the drawings are indicated by the common reference numerals.

### First Embodiment

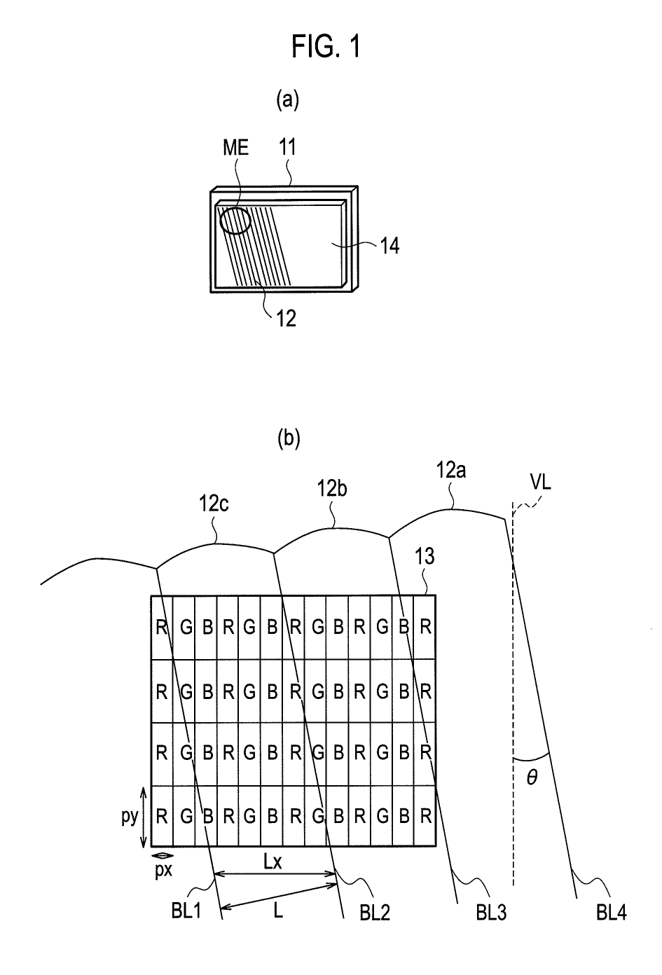

A constitution of an autostereoscopic display apparatus according to a first embodiment of the present invention will be explained with reference to FIG. 1(a) and FIG. 1(b). The autostereoscopic display apparatus according to the first embodiment of the present invention includes a two-dimensional display 11 including color subpixels 13 arranged at predetermined pitches in a vertical direction and in a horizontal direction, respectively, and a lenticular sheet 14 provided on the surface of the two-dimensional display 11. The lenticular sheet 14 includes plural cylindrical lenses 12a, 12b, 12c, . . . arranged parallel to each other in a one-dimensional direction. The color subpixels 13 are visually observed through the plural cylindrical lenses 12. The cylindrical lenses 12 have linear boundaries BL1 to BL4 parallel to each other inclined to a vertical direction VL of the two-dimensional display 11. An inclined angle of the boundaries is defined as “θ”.

Each of plural rectangular shapes arranged vertically and horizontally in FIG. 1(b) shows the color subpixel 13 of the two-dimensional display 11. The color subpixels 13 of three (=D) different kinds of colors R (red), G (green) and B (blue) are periodically arranged in the horizontal direction, and the color subpixels of each color are arranged in the vertical direction. Here, a lens pitch vertical to the boundaries BL1 to BL4 of the cylindrical lenses 12 (hereinafter, simply referred to as “a lens pitch”) is defined as “L”, and a lens pitch of the cylindrical lenses 12 in the horizontal direction (hereinafter, simply referred to as “a horizontal lens pitch”) is defined as “Lx”. In addition, a pixel pitch of the color subpixels 13 in the horizontal direction (hereinafter, simply referred to as “a horizontal pixel pitch”) is defined as “px”, and a pixel pitch of the color subpixels 13 in the vertical direction (hereinafter, simply referred to as “a vertical pixel pitch” is defined as “py”. In the following explanations, although the condition of py/px=3 is applied, py/px may be other numerical values other than three. The cylindrical lenses 12a, 12b, 12c, . . . refract light only in a direction vertical to the boundaries BL1 to BL4.

Next, a method of segmenting an image into parallax images as finely as possible without increasing resolution of the two-dimensional display 11 will be explained.

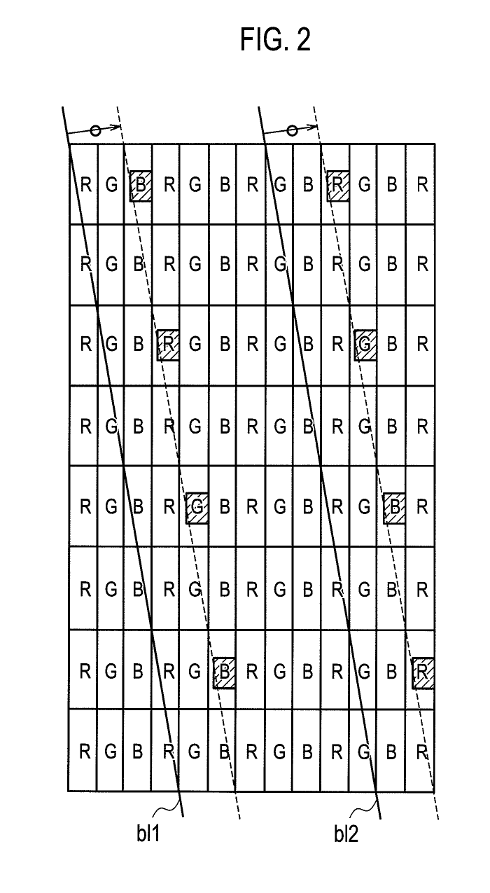

FIG. 2 shows a first comparative example in which the inclined angle θ of the cylindrical lenses is set to θ=arctan(px/(2·py))=9.46°, and the horizontal lens pitch Lx is set to Lx=7·px. When the color subpixels of the two-dimensional display 11 are viewed through the cylindrical lenses from a particular direction, only the color subpixels at the same distance from boundaries bl1 and bl2 of the cylindrical lenses can be viewed. The distance of the viewable color subpixels from the boundaries bl1 and bl2 varies depending on the viewing direction. The color subpixels of three colors R, G and B periodically appear along the boundary bl1 and thus, the respective color subpixels are arranged evenly in a screen of the two-dimensional display 11.

However, in the first comparative example of FIG. 2, since the horizontal lens pitch Lx is the integral multiple of the horizontal pixel pitch px, the segmentation of the color subpixels of the two-dimensional display 11 relative to the boundaries bl1 and bl2 cannot be made into the horizontal pixel pitch px or lower.

In view of this, as described above, the horizontal lens pitch Lx is deviated from the integral multiple of the horizontal pixel pitch px so that the segmentation of the color subpixels of the two-dimensional display 11 relative to the boundaries bl1 and bl2 is made into the horizontal pixel pitch px or lower. As a result, the segmented parallax images are arranged across the plural cylindrical lenses. Accordingly, the segmentation number of the parallax images can be increased without an increase in resolution of the two-dimensional display 11.

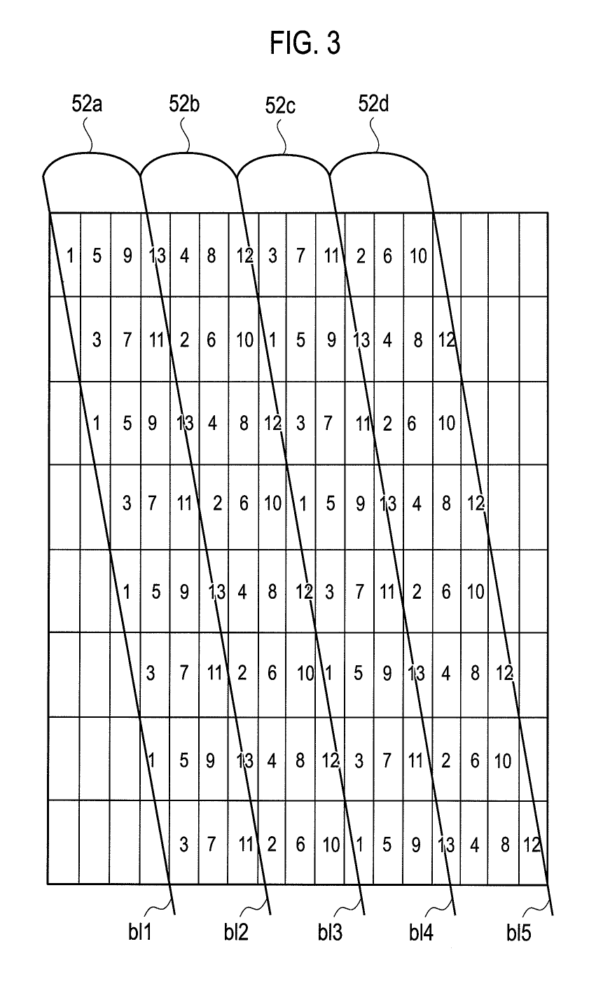

FIG. 3 shows a second comparative example in which θ is set to 9.46°, and the horizontal lens pitch Lx=L/cos θ is set to 13·px/4=3.25·px. The numbers indicated in each color subpixel represent the numbers of 13 segmented parallax images. The 13 segmented parallax images are arranged across four cylindrical lenses 52a to 52d.

Here, in the second comparative example, there is a problem of generation of oblique line noise parallel to the boundaries bl1 to bl5 of the cylindrical lenses 52a to 52d.

According to FIG. 3, the cylindrical lenses 52a and 52c correspond only to the odd-numbered parallax images, and the cylindrical lenses 52b and 52d correspond only to the even-numbered parallax images. Thus, the odd-numbered parallax images are not displayed in the cylindrical lenses 52b and 52d, and the even-numbered parallax images are not displayed in the cylindrical lenses 52a and 52c. When parallax images SP1 to SP13 having a parallax in the horizontal direction are sequentially allocated to the cylindrical lenses, oblique line noise parallel to the boundaries bl1 to bl5 of the cylindrical lenses 52a to 52d is caused. Further, when the horizontal lens pitch Lx is adjusted to obtain further finely segmented parallax images, the number of the viewpoints not displayed is increased when one cylindrical lens is observed. As a result, the oblique line noise is further distinguished.

On the other hand, according to the first embodiment of the present invention, all of the parallax images SP1 to SP13 can be displayed at least once in each of the cylindrical lenses 52a to 52d by the proper setting of the inclined angle θ of the cylindrical lenses 52a to 52d. As a result, it is possible to prevent a generation of oblique line noise parallel to the boundaries bl1 to bl5 of the cylindrical lenses 52a to 52d in the entire parallax view even when the horizontal lens pitch Lx is deviated from the integral multiple of the horizontal pixel pitch px and the segmented parallax images are displayed across the plural cylindrical lenses 52a to 52d.

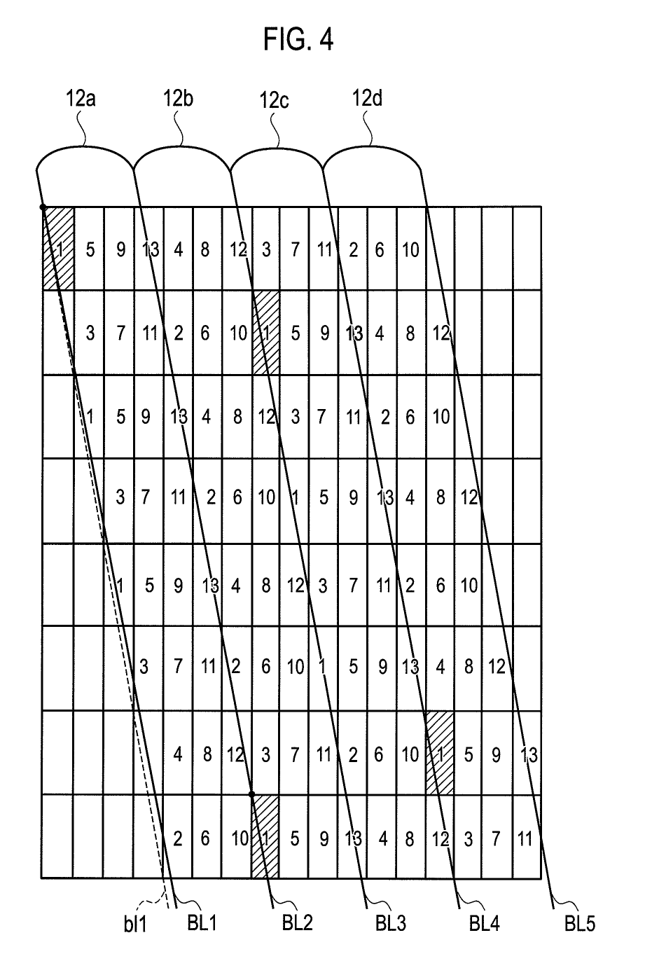

FIG. 4 shows the first embodiment of the present invention in which θ=10.23°, and Lx=3.25·px. Compared with the second comparative example of FIG. 3, the inclined angle θ is changed from 9.46° to 10.23°. With the change of the inclined angle θ, the boundary of the cylindrical lens is shifted from the boundary bl1 to the boundary BL1. The same applies to the other boundaries. In the example shown in FIG. 4, all of the parallax images 1 to 13 appear in each of the cylindrical lenses 12a to 12d. Therefore, oblique line noise caused in the second comparative example shown in FIG. 3 can be prevented.

In particular, the horizontal pixel pitch px, the vertical pixel pitch py, the horizontal lens pitch Lx of the cylindrical lenses 12a to 12d, and the inclined angle θ of the boundaries BL1 to BL5 of the cylindrical lenses 12a to 12d are only required to satisfy each relational expression represented by the formula (1), the formula (2) and the formula (3). Here, Ax and Ay are relatively prime natural numbers, and Bx is a minimum natural number by which the numerical value GF indicated in the formula (2) represents an integer value.

θ=arctan {(Ax·px)/(Ay·py)} (1)

GF=Bx·Lx/px (2)

Ay≧Bx≧2 and Ax≧2 (3)

When px, py, Lx and θ satisfy the relational expressions represented by the formula (1) to the formula (3), the number V of the parallax images segmented is represented by the formula (8). Here, {Bx, Ay} represents a least common multiple of Bx and Ay.

V={Bx, Ay}·Lx/py (8)

When the condition of Bx≧2 in the formula (3) is fulfilled, the horizontal lens pitch Lx can be deviated from the integral multiple of the horizontal pixel pitch px. Therefore, since the segmentation of the parallax images across the plural cylindrical lenses can be possible, the segmentation number of the parallax images is increased without an increase of the horizontal lens pitch Lx with respect to the horizontal pixel pitch px. Further, when the condition of Ay≧Bx is fulfilled, all of the parallax images are displayed at least once in each of the cylindrical lenses 12a to 12d. Accordingly, even when the horizontal lens pitch Lx is deviated from the integral multiple of the horizontal pixel pitch px, and the segmentation of the parallax images is made across the multiple cylindrical lenses 12a to 12d, it is possible to prevent a generation of oblique line noise parallel to the boundaries BL1 to BL5 of the cylindrical lenses 12a to 12d in the entire parallax view. Note that it is assumed that the size of a screen of the two-dimensional display 11 in the autostereoscopic display apparatus is limitless.

When the color subpixels of the two-dimensional display 11 are observed through the cylindrical lenses 12a to 12d, the color subpixels are enlarged and resolution of the parallax images is reduced. The size of the enlarged color subpixels is proportional to the lens pitch L and 1/tan θ. The size of the color subpixels is increased as θ is decreased and as a result, the resolution of the parallax images is reduced. When Ax≧2 is fulfilled, an excessive decrease of θ is prevented even if Bx and Ay are increased. Accordingly, a reduction in resolution can be prevented.

### Second Embodiment

According to the first embodiment, a generation of oblique line noise is prevented. However, unevenness of color may be caused depending on the values of the lens pitch L and the inclined angle θ. In particular, when the horizontal lens pitch Lx is deviated from the integral multiple of the horizontal pixel pitch px, and Ax is equal to or larger than two, the inclined angle θ of the cylindrical lenses 12a to 12d is deviated from θ=arctan(px/(C*py)) (wherein C is a natural number). Therefore, the color subpixels indicating the identical parallax images cause a color distribution in the screen of the two-dimensional display 11 according to the relative position between the cylindrical lenses 12a to 12d and the color subpixels. As a result, unevenness of color may be caused due to the color distribution.

Hereinafter, an autostereoscopic display apparatus capable of preventing unevenness of color caused in the vertical direction of the boundaries BL of the cylindrical lenses 12 according to the second embodiment will be explained.

In the autostereoscopic display apparatus according to the second embodiment, two color subpixels observed through the two cylindrical lenses 12 adjacent to each other and having a minimum relative distance, among the color subpixels indicating the identical parallax images, are different in color. The inclined angle θ is configured in such a manner that the two color subpixels have different colors approximately in the entire region of the screen of the two-dimensional display 11. Accordingly, an uneven distribution of the color subpixels of the identical colors can be prevented and therefore, unevenness of color due to the uneven color distribution can be prevented.

In particular, when α and β, by which GH in the formula (7) represents a minimum value, among the natural numbers α and β satisfying the formula (6) are defined as α₀ and β₀, each numerical value of px, py, Lx and θ is set in such a manner that α₀ is not a multiple of D. Here, D represents the number of colors of the color subpixels included in the two-dimensional display 11. Note that it is only required that α₀ is not a multiple of three since the color subpixels of three colors R, G and B have a periodically-arranged constitution.

α·px+β·py·tan θ=Lx (6)

GH=(α·px)²+(β·py)² (7)

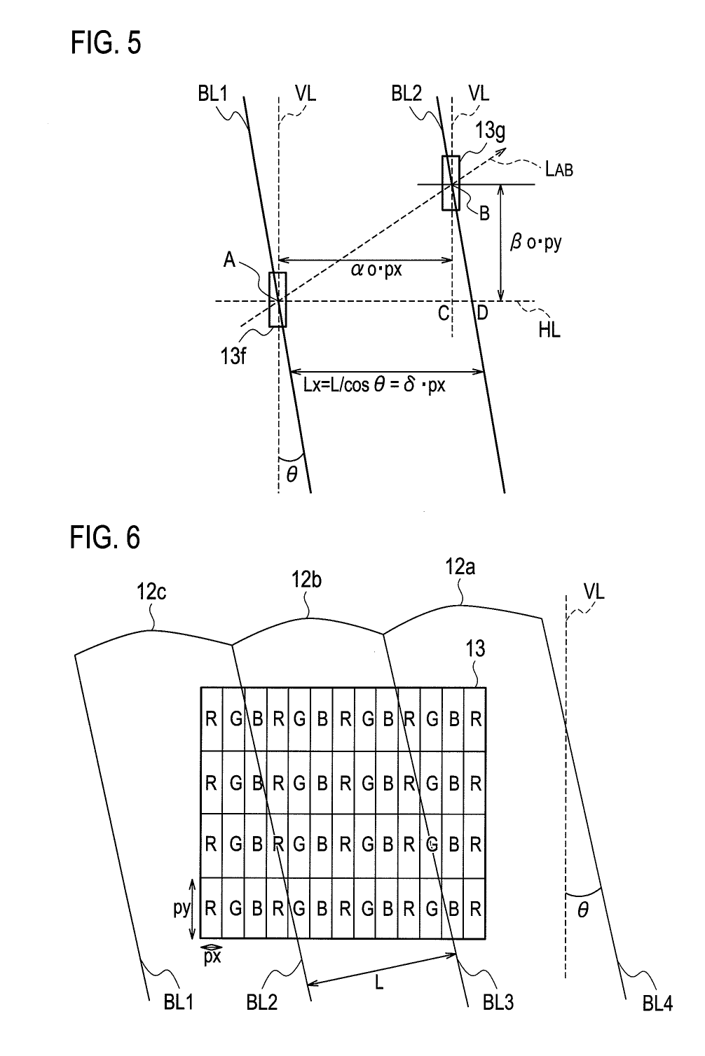

Next, the formula (6) and the formula (7) are explained with reference to FIG. 5. FIG. 5 shows arbitrary two color subpixels 13f and 13g, and the boundaries BL1 and BL2 of the cylindrical lens 12. The boundary BL1 passes through a center A of the color subpixel 13f, and the boundary BL2 passes through a center B of the color subpixel 13g. When focusing on triangles BAC and BCD, it is recognized that the natural numbers α and β are required to satisfy the formula (6). Further, it is recognized that it is only required that α₀ is not a multiple of three in order for the color subpixel 13f and the color subpixel 13g to have different colors.

When the screen of the two-dimensional display 11 is viewed through the cylindrical lenses 12, the different colors arranged in order of such as R, G, B, R, . . . or R, B, G, R, . . . are displayed constantly along a straight line L_{AB}. A length (GH^{1/2}) of a segment of the center A and the center B is a relative distance of the color subpixels 13f and 13g. The respective α₀ and β₀ are selected in such a manner that the relative distance is a minimum value. Therefore, the color subpixels of R, G and B are arranged sequentially in the direction of the line AB with a small period (3×GH^{1/2}). As a result, unevenness of color can be prevented.

In the first and second embodiments of the present invention, the two-dimensional display 11 including the color subpixels of three colors R, G and B periodically arranged in the horizontal direction was explained. Alternatively, the two-dimensional display in which the color subpixels of four colors further including Y (yellow) or the color subpixels of multiple colors of more than four are periodically arranged in the horizontal direction can also prevent unevenness of color if the numerical value of α₀ is not a multiple of the color number (D).

### Example 1

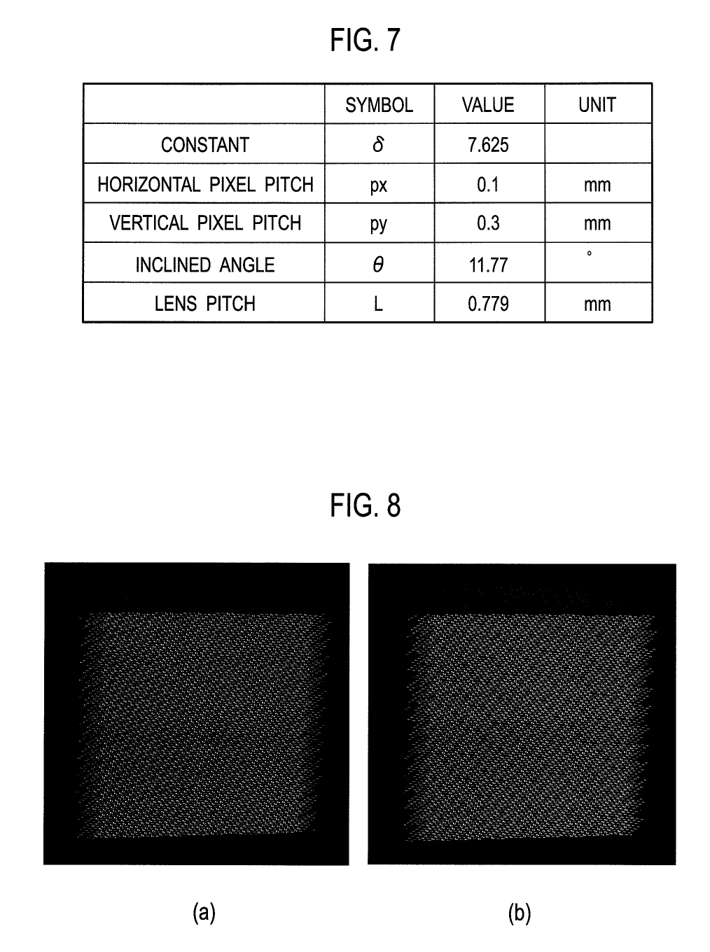

Based on the above explanations, Example 1 related to the first and second embodiments will be explained below. FIG. 6 is a plan view showing a constitution of the auto stereoscopic display apparatus according to Example 1. FIG. 7 is a table showing preconditions of each parameter of the autostereoscopic display apparatus shown in FIG. 6. As in the case of the autostereoscopic display apparatus of FIG. 1, the color subpixels are arranged at predetermined pitches in the vertical direction and in the horizontal direction, respectively. The color subpixels of the identical colors are arranged in the vertical direction, and the color subpixels of R (red), G (green) and B (blue) are periodically arranged in the horizontal direction. The plural cylindrical lenses 12a, 12b, 12c, . . . are arranged parallel to each other in a one-dimensional direction. Each color subpixel is observed through the plural cylindrical lenses 12a, 12b, 12c, . . . . The boundaries BL1 to BL4 of the cylindrical lenses 12a to 12c are inclined to the vertical direction VL of the two-dimensional display 11 at the inclined angle θ. Here, the horizontal pixel pitch is px=0.1 mm, and the vertical pixel pitch is py=0.3 mm.

As shown in FIG. 7, the inclined angle θ and the lens pitch L are respectively set to θ=11.77° and L=0.779 mm. The formula (1) is satisfied when Ax=5 and Ay=8, and the constant Bx with regard to the lens pitch fulfills Bx=8; that is, Bx=Ay=8. Further, the formula (6) is satisfied when α₀=7 and β₀=1. Therefore, the color subpixels of the different colors are arranged closer to each other than the color subpixels of the identical colors. Thus, a smooth color quality without unevenness of color can be realized.

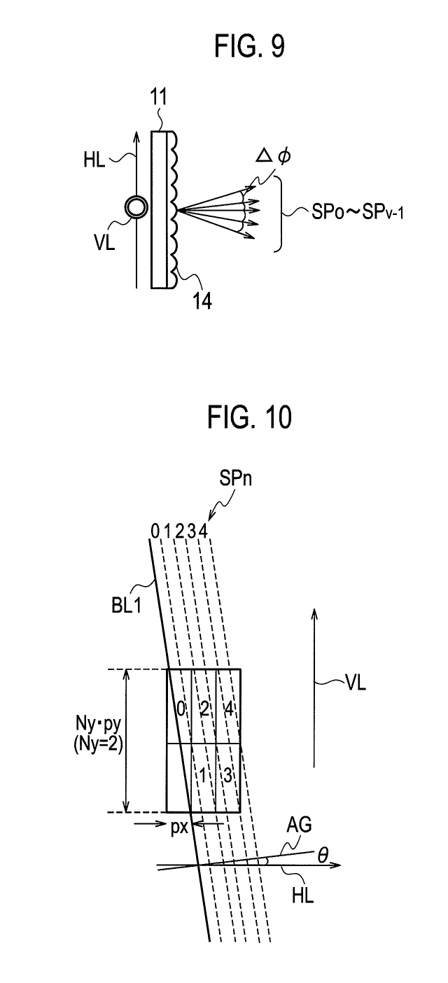

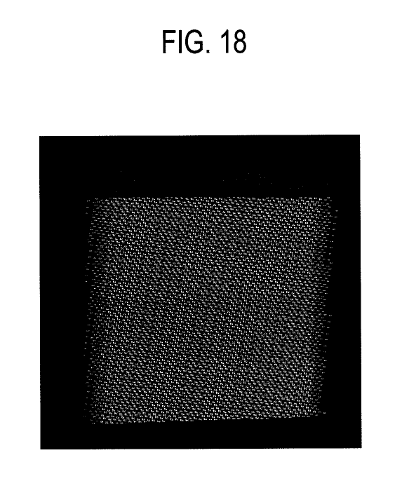

FIG. 8 is simulation images when observing the 61 segmented parallax images from one point through the cylindrical lenses 12 in the same manner as FIG. 18. FIG. 8(a) shows the case in which the parallax images with respect to the lens pitch of L=0.779 mm as shown in FIG. 9 are observed through the cylindrical lenses 12. It can be seen that there is no color unevenness or oblique line noise. FIG. 8(b) shows the case in which the parallax images, which are reconstructed in accordance with the relative position between the cylindrical lenses 12 and the color subpixels in view of a 0.5%-broadening of the lens pitch L, are observed through the cylindrical lenses 12. It can be seen that the oblique line noise observed in FIG. 18 is not caused in FIG. 8(b) even though the parallax images are reconstructed.

As is explained above, according to Example 1, it is possible to prevent oblique line noise and color unevenness even when the horizontal lens pitch Lx of the cylindrical lenses 12 is deviated from the integral multiple of the horizontal pixel pitch px, and the segmentation number of the parallax images is increased without an increase of the lens pitch L. Further, it is possible to prevent a generation of oblique line noise even when the parallax images are reconstructed in accordance with the change of the lens pitch L.

### Third Embodiment

A constitution of an autostereoscopic display apparatus according to a third embodiment of the present invention will be explained with reference to FIG. 9. The autostereoscopic display apparatus includes the two-dimensional display 11 such as a liquid crystal display device (LCD), and the lenticular sheet 14 tightly attached to the screen of the two-dimensional display 11 via an adhesion layer (not shown in the figure) having a negligible thickness.

The lenticular sheet 14 is composed of the plural cylindrical lenses 12. The V parallax images SP₀ to SP_{V-1} segmented in a horizontal direction HL are displayed by a focusing effect of the cylindrical lenses 12. An angle pitch of the parallax images SP₀ to SP_{V-1} adjacent to each other is defined as “a parallax angle pitch Δφ” as an index that represents fineness of segmentation of the parallax images SP₀ to SP_{V-1}.

Next, a relationship between the parallax angle pitch Δφ and each parameter is described. A focus distance of the cylindrical lenses 12 is defined as “f”. When the cylindrical lenses 12 focus on the screen of the two-dimensional display 11, the parallax angle pitch Δφ is represented by the formula (9).

Δφ=Lx/(cos θ·f·v) (9)

Next, a method of finer segmenting into the parallax images without an increase in resolution of the two-dimensional display 11 is explained. First, px/(py·tan θ) is calculated from the inclined angle θ of the cylindrical lenses 12, and the closest natural number is defined as Ny. Note that Ny=1 is fulfilled in the case of θ=0. FIG. 10 shows a positional relationship between the color subpixels and the boundary BL1 of the cylindrical lens 12 in the case of Ny=2. Regions 0 to V−1 separated by the boundary BL1 of the cylindrical lens 12 and plural dotted lines parallel to the boundary BL1 are indexes to determine the color subpixels corresponding to each parallax image SPn (n=0 to V−1). The corresponding parallax images SP₀, SP₁, . . . , SP_{V-1} are determined according to the regions 0 to V−1 to which the center of each color subpixel corresponds.

As shown in FIG. 10, the inclined angle θ of the cylindrical lens 12 is set in such a manner that Ny is set to approximately 2 subpixels in the vertical direction with respect to one subpixel in the horizontal direction. Therefore, a horizontal coordinate position with respect to the cylindrical lens 12 is shifted by 1/2 pixels (px/2) between the upper color subpixels and the lower color subpixels adjacent to each other in the vertical direction. Thus, the upper color subpixels correspond to the even-numbered parallax images SP₀, SP₂ and SP₄, and the lower color subpixels correspond to the odd-numbered parallax images SP₁ and SP₃. Accordingly, the fineness of segmentation of the parallax images can be increased by Ny times. In FIG. 10, the inclined angle θ is indicated as an angle formed between the horizontal direction HL of the two-dimensional display 11 and a direction AG vertical to the boundary BL1 of the cylindrical lens.

Next, the conditional expressions to shift the horizontal lens pitch Lx to the integral multiple of the horizontal pixel pitch px are represented by the formula (5-1) and the formula (5-2). Here, M and K are natural numbers, and Nx is a natural number equal to or larger than two.

Lx=L/cos θ=(M/Nx)·px (5-1)

M=K·Nx±1 (5-2)

The formula (5) is obtained by substituting the formula (5-1) in the formula (5-2).

Lx=(K±1/Nx)px (5)

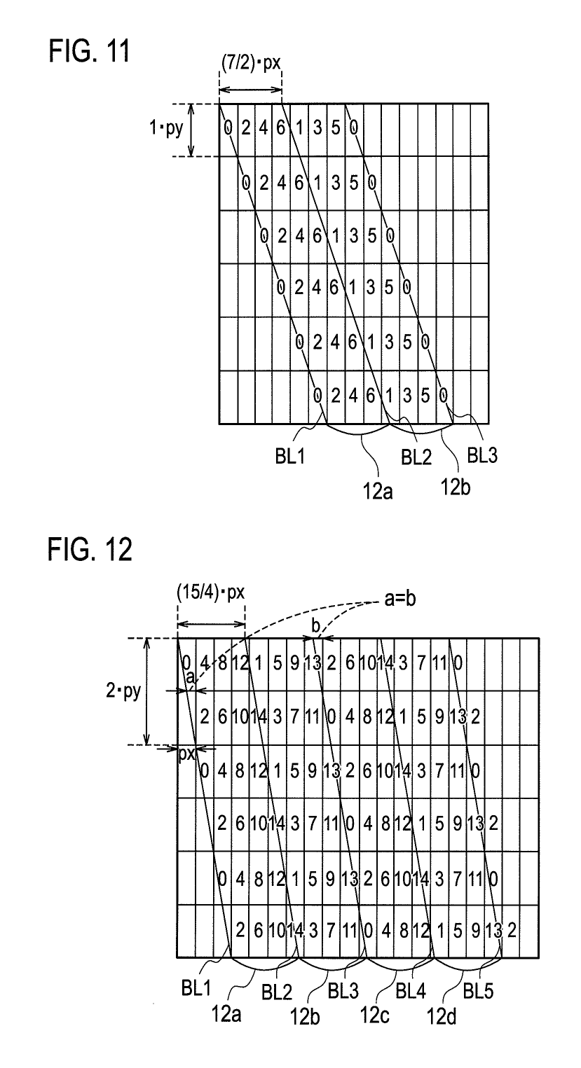

When Lx and px satisfy the conditional expressions of the formula (5-1) and the formula (5-2), images from M subpixels arranged in the horizontal direction across Nx lenses is segmented in the M directions. FIG. 11 shows an arrangement of the color subpixels in the case of Ny=1, Nx=2 and M=7 in a similar manner to FIG. 10. As is obvious from FIG. 11, the viewable parallax images are separated in the cylindrical lens 12a and the cylindrical lens 12b. The cylindrical lens 12a displays the even-numbered parallax images SP₀, SP₂, SP₄ and SP₆, and the cylindrical lens 12b displays the odd-numbered parallax images SP₁, SP₃ and SP₅.

FIG. 12 shows an arrangement of the color subpixels in the case of Ny=2, Nx=4 and M=15 in a similar manner to FIG. 10. In this case, the amount of horizontal displacement (“a” in FIG. 12) to the boundary BL1 of the cylindrical lens 12a from the color subpixel when shifting by one color subpixel in the vertical direction corresponds to the amount of horizontal displacement (“b” in FIG. 12) to the boundary BL3 from the color subpixel when shifting by two cylindrical lenses 12a and 12b in the horizontal direction. The same applies to the cylindrical lens 12b and the cylindrical lens 12d. Therefore, the effect of increasing the segmentalization capacity in the horizontal direction derived from Ny=2 is included in the effect derived from Nx=4. However, the numbers of the parallax images of the cylindrical lenses 12a and 12c are not identical to those of the cylindrical lenses 12b and 12d. In other words, as exemplified in FIG. 11 and FIG. 12, each of the cylindrical lenses 12a to 12d cannot display all the parallax images SP₀ to SP₁₄ when Nx>Ny. As a result, oblique line noise is caused.

The segmentation number V of the parallax images in the horizontal direction can be represented by the formula (10) in addition to the formula (8). Here, {Nx, Ny} represents a least common multiple of the natural numbers Nx and Ny.

V=(M/Nx)·{Nx, Ny} (10)

The parallax angle pitch Δφ is represented by the formula (11) in accordance with the formula (9), the formula (5) and the formula (10). According to the formula (11), the parallax angle pitch Δφ is determined by the pixel pitch px, the focus distance f, and the constants Nx and Ny. By adjusting Nx and Ny, the parallax angle pitch Δφ is decreased, and the segmentation number of the parallax images is increased without a change of px.

$$Δ φ = \frac{px}{\{ Nx , Ny \} \cdot f} \qquad ( 11 )$$

Next, a method of setting the inclined angle θ is explained. According to the third embodiment of the present invention, when the horizontal lens pitch Lx is represented by the formula (5), the inclined angle θ is determined by the formula (4). Here, Gy is a natural number, Gx is a natural number equal to or larger than two, and Nx≧Ny.

$$θ = arctan \frac{( Gx \pm \frac{1}{Nx} ) \cdot px}{Gy \cdot Ny \cdot py} \qquad ( 4 )$$

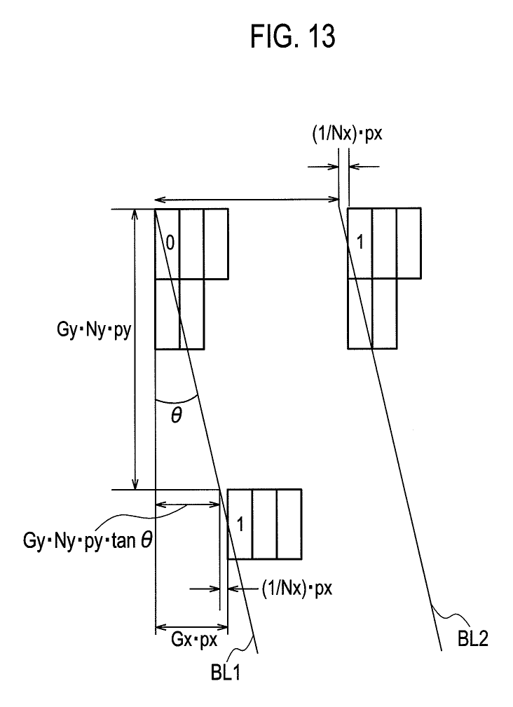

When the inclined angle θ is determined according to the formula (4), as shown in FIG. 13, the boundary BL1 is inclined at the amount corresponding to Gx±1/Nx subpixels in the horizontal direction with respect to the Gy·Ny color subpixels in the vertical direction. Namely, a displacement of ±1/Nx subpixels from the integral multiple (Gx times) of the horizontal pixel pitch px is generated. In addition, according to the formula (5), the horizontal lens pitch Lx is shifted by ±1/Nx subpixels from the integral multiple of the horizontal pixel pitch px. Accordingly, as shown in FIG. 13, the corresponding numbers of the parallax images are exchanged between the cylindrical lenses adjacent to each other with the period of the Gy·Ny subpixels in the vertical direction. When the cylindrical lenses 12 are sufficiently long in the vertical direction with respect to the color subpixels, all the parallax images are displayed at least once in each of the cylindrical lenses. Therefore, it is possible to prevent a generation of oblique line noise parallel to the boundaries BL1 and BL2 of the cylindrical lenses 12 in the entire parallax view. In addition, it is possible to prevent the color subpixels from being excessively enlarged when the condition of Gx≧2 is fulfilled. When the color subpixels of the two-dimensional display 11 are observed through the cylindrical lenses 12, the subpixels are enlarged to result in a reduction in resolution. The size of the enlarged color subpixels is proportional to the lens pitch L and 1/tan θ. Therefore, it is preferable to increase the inclined angle θ to some extent. Thus, the condition of Gx≧2 has the effect of preventing an excessive decrease of θ even when Nx, Ny and Gy are increased.

### Modified Example of Third Embodiment

For the purpose of preventing oblique line noise, one cylindrical lens 12 may be assigned all the parallax images by determining the inclined angle θ of the cylindrical lens 12 not depending on the value of Gy in the formula (4). However, if the two-dimensional display 11 is a color display device in which the color subpixels of three (=D) different colors R (red), G (green) and B (blue) are arranged periodically, unevenness of color may be caused along the boundaries BL of the cylindrical lenses 12.

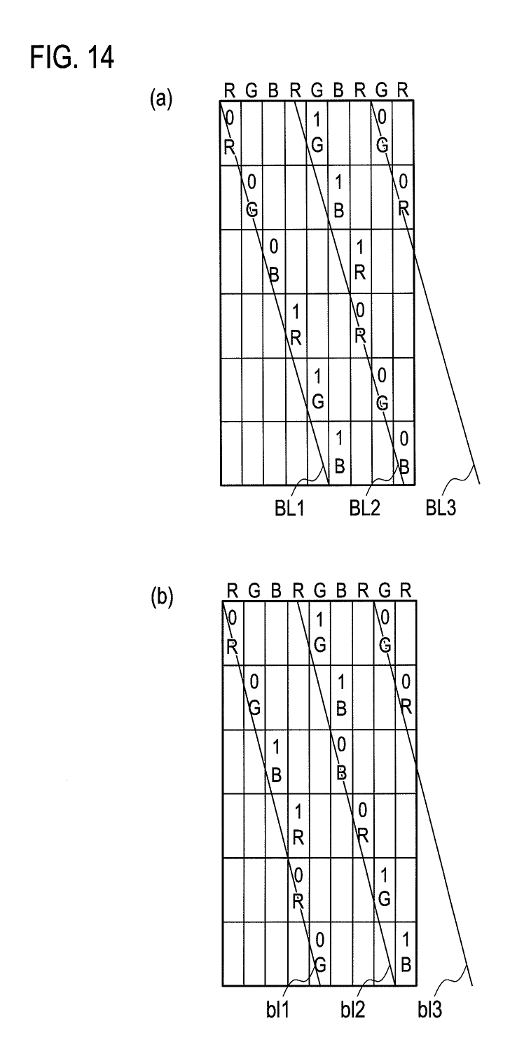

As shown in FIG. 14(a), each set of the color subpixels of approximately R, G and B corresponding to the same numbers of the parallax images is arranged along the boundaries BL1 to BL3 in the case of Gy≈3. In the case of Gy=2, as shown in FIG. 14(b), each set of the color subpixels of two colors among R, G and B is arranged obliquely. Thus, unevenness of color may be caused depending on the area. In the case in which Gy is equal to or larger than four, the period in the vertical direction to shift the numbers of the parallax images is extended. As a result, the effect of preventing oblique line noise is decreased. Therefore, Gy=3 (=D) is preferable.

When the lens pitch L and the inclined angle θ of the cylindrical lenses 12 are set in such a manner that Nx and Ny are increased, the parallax angle pitch Δφ can be decreased as much as desired. However, visibility is saturated at particular values of Nx and Ny while the throughput and the data amount when generating the parallax images are increased. On the other hand, according to the third embodiment, the parallax angle pitch Δφ can be decreased and the segmentation number V can be increased while setting Nx and Ny to finite values and maintaining regularity at the time of allocating the parallax images to the respective color subpixels. Therefore, well-known methods of creating multi-view images and multi-parallax images can be applied directly to a content production and an image conversion. These applications contribute to simplifying processing. This is a different point from techniques using an integral imaging method.

In the modified example of the third embodiment of the present invention, the two-dimensional display 11 in which the color subpixels of three colors R, G and B are arranged periodically in the horizontal direction was explained. However, the two-dimensional display in which the color subpixels of four colors further including Y (yellow) or the color subpixels of multiple colors more than four are arranged periodically in the horizontal direction is also applicable to this example by changing the value of Gy depending on the color number (D).

### Example 2

Examples 2 and 3 related to the third embodiment will be explained using the parameters and the relational expressions described above. The fundamental structure of the autostereoscopic display apparatus according to Example 2 is shown in FIG. 9. The LCD panel serving as the two-dimensional display 11 is a color LCD display device in which color subpixels of R (red), G (green) and B (blue) are periodically arranged in a stripe state in the horizontal direction.

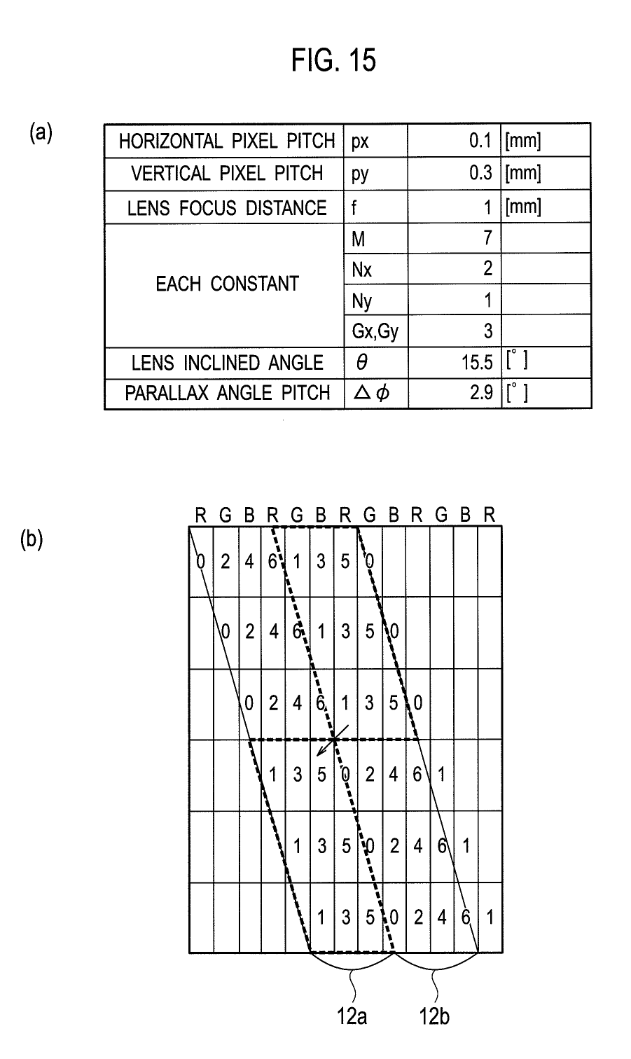

FIG. 15(a) shows preconditions of Example 2 including the horizontal pixel pitch px=0.1 mm, the vertical pixel pitch py=0.3 mm, the lens focus distance f=1 mm, and each constant M=7, Nx=2, Ny=1, Gx=3 and Gy=3. The calculation result of the inclined angle θ of the cylindrical lenses 12 according to the formula (4) is θ=15.5°. In this case, “−” was selected from “±” in the formula (4). The calculation result of the parallax angle pitch Δφ based on the inclined angle θ is Δφ=2.9°. These values can be certainly calculated by selecting “+”.

FIG. 15(b) shows the cylindrical lenses 12a and 12b of Example 2 constituted according to FIG. 15(a) and the numbers of the parallax images corresponding to the respective color subpixels in a similar manner to FIG. 10. A comparative example with respect to Example 2 corresponds to the constitution shown in FIG. 11. In the comparative example shown in FIG. 11, only the color subpixels corresponding to the parallax images SP₀, SP₂, SP₄ and SP₆ are displayed through the cylindrical lens 12a, and only the color subpixels corresponding to the parallax images SP₁, SP₃ and SP₅ are displayed through the cylindrical lens 12b.

On the other hand, in Example 2 shown in FIG. 15(b), all the color subpixels corresponding to the parallax images SP₀ to SP₆ are displayed in each of the cylindrical lenses 12a and 12b. More specifically, as described above, the parallax images SP₀ to SP₆ displayed in the cylindrical lenses 12a and 12b are exchanged per G·Ny=3 subpixels in the vertical direction. In particular, the odd-numbered parallax images SP₁, SP₃ and SP₅ and the even-numbered parallax images SP₀, SP₂, SP₄ and SP₆ are exchanged between the cylindrical lenses 12a and 12b adjacent to each other per Gy·Ny=3 subpixels in the vertical direction. As is evident in FIG. 15(b), a set of the parallax image numbers indicated by a dotted diamond shape is exchanged for the other set of the parallax image numbers. Thus, according to Example 2, since all the parallax images SP₀ to SP₆ can be allocated to each of the cylindrical lenses 12a and 12b, it is possible to prevent oblique line noise along the boundaries BL1 and BL2 of the cylindrical lenses 12a and 12b. In addition, since the color subpixels of the three different colors can be periodically arranged along the boundaries BL1 and BL2 when the condition of Gy=3 is fulfilled, unevenness of color is not caused.

### Example 3

Example 3 related to the third embodiment will be explained. The entire constitution of the autostereoscopic display apparatus according to Example 3 is the same as Example 2, and the explanation thereof will not be repeated.

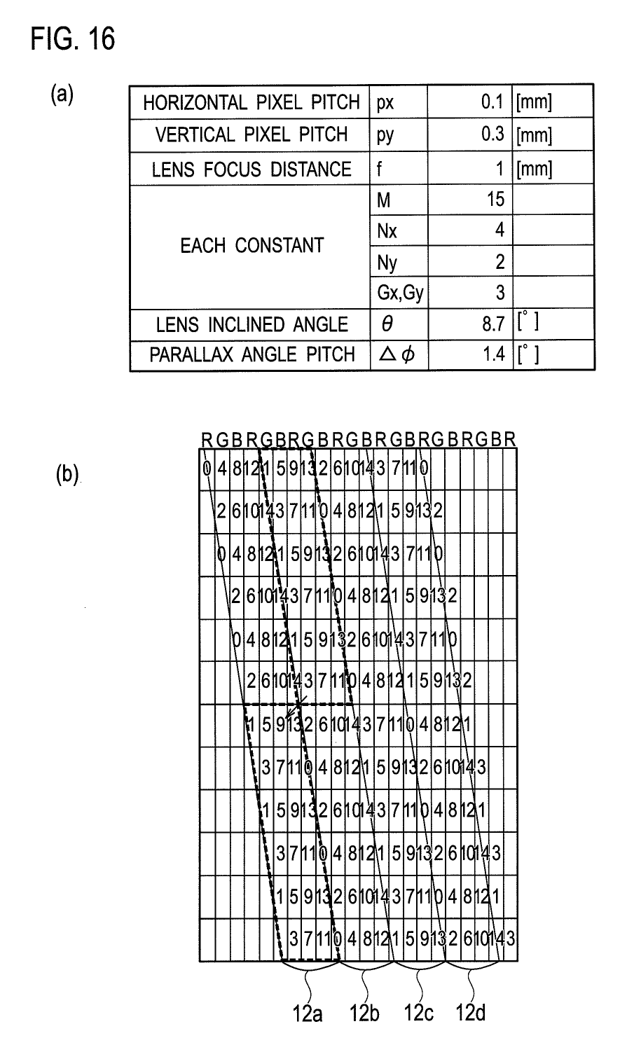

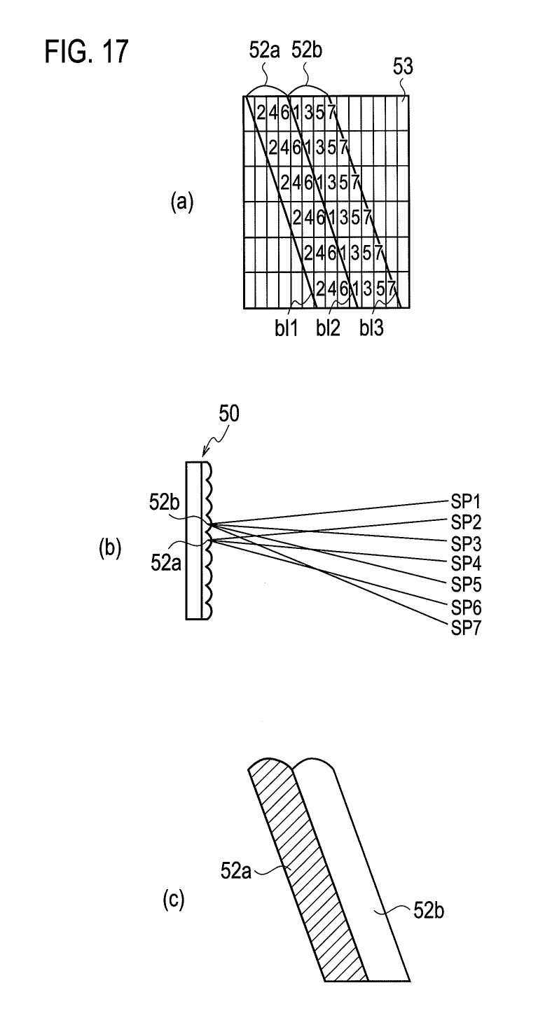

FIG. 16(a) shows preconditions of Example 3 including the horizontal pixel pitch px=0.1 mm, the vertical pixel pitch py=0.3 mm, the lens focus distance f=1 mm, and each constant M=15, Nx=4, Ny=2, Gx=3 and Gy=3. The calculation result of the inclined angle θ of the cylindrical lenses 12 according to the formula (4) is θ=8.7°. In this case, “−” was selected from “±” in the formula (4). The calculation result of the parallax angle pitch Δφ based on the inclined angle θ is Δφ=1.4°. These values can be certainly calculated by selecting “+”.

FIG. 16(b) shows the cylindrical lenses 12a to 12d of Example 2 constituted according to FIG. 16(a) and the numbers of the parallax images corresponding to the respective color subpixels in a similar manner to FIG. 10. A comparative example with respect to Example 3 corresponds to the constitution shown in FIG. 12. In the comparative example shown in FIG. 12, only the color subpixels corresponding to the parallax images SP₀, SP₂, SP₄, SP₆, SP₈, SP₁₀, SP₁₂ and SP₁₄ are displayed through the cylindrical lenses 12a and 12c, and only the color subpixels corresponding to the parallax mages SP₁, SP₃, SP₅, SP₇, SP₉, SP₁₁ and SP₁₃ are displayed through the cylindrical lenses 12b and 12d.

On the other hand, in Example 3 shown in FIG. 16(b), all the color subpixels corresponding to the parallax images SP₀ to SP₁₄ are displayed in each of the cylindrical lenses 12a to 12d. More specifically, as described above, the parallax images SP₀ to SP₁₄ displayed in the cylindrical lenses 12a to 12d are exchanged per Gy·Ny=6 subpixels in the vertical direction. In particular, the odd-numbered parallax images SP₁ to SP₁₃ and the even-numbered parallax images SP₀ to SP₁₄ are exchanged between the cylindrical lenses 12a and 12c and the cylindrical lenses 12b and 12d adjacent to each other, respectively, per Gy·Ny=6 subpixels in the vertical direction. As is evident in FIG. 16(b), a set of the parallax image numbers indicated by a dotted diamond shape is exchanged for the other set of the parallax image numbers. Thus, according to Example 3, since all the parallax images SP₀ to SP₁₄ can be allocated to each of the cylindrical lenses 12a to 12d, it is possible to prevent oblique line noise along the boundaries of the cylindrical lenses 12a to 12d. In addition, since the color subpixels of the three different colors can be periodically arranged along the boundaries of the cylindrical lenses 12a to 12d when the condition of Gy=3 is fulfilled, unevenness of color is not caused.

Although the present invention has been described above by reference to the three embodiments and the three examples, the present invention is not limited to the descriptions and the drawings composing part of the disclosure of the present invention. It will be apparent to those skilled in the art that various modified embodiments, examples and operational techniques can be available from the disclosure of the present invention.

Although the liquid crystal display (LCD) panel and the color LCD display device were exemplified as the two-dimensional display 11, other two-dimensional displays such as a cathode-ray tube (CRT), a plasma display, an electronic paper and EL (electroluminescence) display may be used.

The autostereoscopic display apparatus according to the embodiments of the present invention includes the two-dimensional display including the color subpixels that are arranged in the horizontal direction and in the vertical direction, respectively, and the plural cylindrical lenses provided on the two-dimensional display to observe the color subpixels therethrough and arranged parallel to each other. When Ax and Ay are relatively prime natural numbers, Ax is equal to or larger than two, and Bx is a minimum natural number by which a value GF indicated in the formula (2) represents an integer value, the pixel pitch px of the color subpixels in the horizontal direction, the pixel pitch py of the color subpixels in the vertical direction, the lens pitch Lx of the cylindrical lenses in the horizontal direction, and the inclined angle θ of the boundaries of the cylindrical lenses to the vertical direction satisfy the relational expressions represented by the formula (1) to the formula (3). Therefore, even when the lens pitch in the horizontal direction is deviated from the integral multiple of the pixel pitch in the horizontal direction, and the segmented parallax images are arranged across the plural cylindrical lenses, it is possible to prevent a generation of oblique line noise parallel to the boundaries of the cylindrical lenses in the entire parallax view. Thus, the autostereoscopic display apparatus according to the embodiments of the present invention is industrially applicable.

What is claimed is:

1. An autostereoscopic display apparatus, comprising:
a two-dimensional display including color subpixels that are arranged in a horizontal direction and in a vertical direction, respectively; and
a plurality of cylindrical lenses provided on the two-dimensional display to observe the color subpixels therethrough, and arranged parallel to each other,
wherein when a pixel pitch of the color subpixels in the horizontal direction is defined as px, a pixel pitch of the color subpixels in the vertical direction is defined as py, a lens pitch of the cylindrical lenses in the horizontal direction is defined as Lx, an inclined angle of boundaries of the cylindrical lenses to the vertical direction is defined as θ, Ax and Ay are relatively prime natural numbers, Ax is equal to or larger than two, and Bx is a minimum natural number by which a value GF indicated in the formula (2) represents an integer value,
θ=arctan{(Ax·px)/(Ay·py)} (1)
GF=Bx·Lx/px (2)
Ay≧Bx≧2 and Ax≧2 (3)
px, py, Lx and θ satisfy relational expressions represented by the formula (1) to the formula (3).

2. The autostereoscopic display apparatus according to claim 1, wherein when Ny, K and Gy are natural numbers, Nx and Gx are natural numbers equal to or larger than two, and Nx≧Ny,
$$\begin{matrix}θ = arctan \frac{( Gx \pm \frac{1}{Nx} ) \cdot px}{Gy \cdot Ny \cdot py} & ( 4 ) \\ Lx = ( K \pm 1 \cdot Nx ) px & ( 5 )\end{matrix}$$
px, py, Lx and θ further satisfy relational expressions represented by the formula (4) and the formula (5).

3. The autostereoscopic display apparatus according to claim 1, wherein in the two-dimensional display, when the color subpixels of D kinds of different colors are periodically arranged in the horizontal direction, the color subpixels of identical colors are arranged in the vertical direction, D is a natural number equal to or larger than three, and α and β, by which GH in the formula (7) represents a minimum value, among natural numbers α and β satisfying the formula (6) are defined as α₀ and β₀,
α·px+β·py·tan θ=Lx (6)
GH=(α·px)²+(β·py)² (7)
α₀ is not a multiple of D.

4. The autostereoscopic display apparatus according to claim 2, wherein in the two-dimensional display, when the color subpixels of D kinds of different colors are periodically arranged in the horizontal direction, the color subpixels of identical colors are arranged in the vertical direction, and D is a natural number equal to or larger than three, Gy is equal to D.

5. An autostereoscopic display apparatus, comprising:
a two-dimensional display configured to display an image using a plurality of color subpixels; and
a plurality of cylindrical lenses configured to segment the image displayed on the two-dimensional display into a plurality of parallax images,
wherein an inclined angle of the cylindrical lenses with respect to the two-dimensional display is set in such a manner that the segmented parallax images are arranged across the cylindrical lenses, and all of the color subpixels composing the parallax images are displayed through each cylindrical lens.

6. The autostereoscopic display apparatus according to claim 5, wherein the inclined angle is set in such a manner that two color subpixels, among color subpixels indicating an identical parallax image, displayed through two cylindrical lenses adjacent to each other and having a minimum relative distance are different in color.
